(19) United States
(12) Patent Application Publication
(10) Pub. No.: US 2012/0141229 A1
(43) Pub. Date: Jun. 7, 2012

(54) WALL HANGING LOAD BEARING DEVICE

(76) Inventor: Jack Lalouf, Houston, TX (US)

(21) Appl. No.: 12/962,232

(22) Filed: Dec. 7, 2010

(51) Int. Cl. F16B 35/04

(52) U.S. Cl. 411/393

(57) ABSTRACT

This invention relates to a wall hanging load bearing device that includes a threaded shaft having a pointed first end and a second end opposite the first end. This invention further includes a disc member connected to the second end of the shaft. The disc member includes a first planar surface, a second planar surface opposite the first planar surface, and an arcuate channel connecting the outer perimeter regions of the first and second planar surfaces. An object to be hung on a wall, such as a painting, can be hung on this invention by placing a wire attached to the back of the painting in the arcuate channel of the disc member. The invention distributes the load of the wall hanging over the perimeter of the disc member.

### BACKGROUND OF THE INVENTION

This invention relates to a wall hanging load bearing device for hanging objects, such as framed pictures or paintings, on walls. Prior art devices for hanging objects from walls include nails, wood screws, and sheetrock screws. The loads that these prior art devices will bear is limited, in part, by their thickness or cross sectional area. The walls where these devices are installed often comprise a sheetrock face that is attached to wooden studs. When a prior art load bearing member bends due to an object that is too heavy being suspended from the member, it can tear the sheetrock, resulting in cosmetic damage to the wall. Additionally, when such bending occurs, the object hung from the prior art load bearing member can fall to the ground, resulting in property damage. The invention disclosed herein can bear a heavier load than prior art wall hanging devices without bending because it distributes the load of the wall hanging over a larger surface area than prior art wall handing devices.

The invention disclosed herein includes a threaded shaft having a pointed first end, and a second end opposite the first end. This invention further includes a disc member connected to the second end of the shaft. The disc member includes a first planar surface, a second planar surface opposite the first planar surface, and an arcuate channel connecting the outer perimeter regions of the first and second planar surfaces. An object to be hung on a wall, such as a painting, can be hung on this invention by placing a wire attached to the back of the painting in the arcuate channel of the disc member. The invention distributes the load of the wall hanging over the perimeter of the disc member.

### DESCRIPTION OF THE DRAWINGS

FIG. 1a is a side view of a first embodiment of the invention disclosed herein.

FIG. 1b is an outer view of a preferred embodiment comprising a circular disc member and a circular arcuate channel.

FIG. 2a is a side view of a second embodiment of the invention disclosed herein.

FIG. 2b is an outer view of a preferred embodiment comprising an elliptical disc member and an elliptical arcuate channel.

FIG. 3 is a cross sectional view of a preferred embodiment of the second end of the shaft shown in FIG. 1.

FIG. 4 is an outer view of a preferred embodiment of the first planar surface of the disc shown in FIG. 1,

FIG. 5 is a cutaway isometric view of a second embodiment of the invention disclosed herein.

FIG. 6 is an isometric view of a first embodiment of the invention disclosed herein.

### DESCRIPTION OF THE PREFERRED EMBODIMENTS

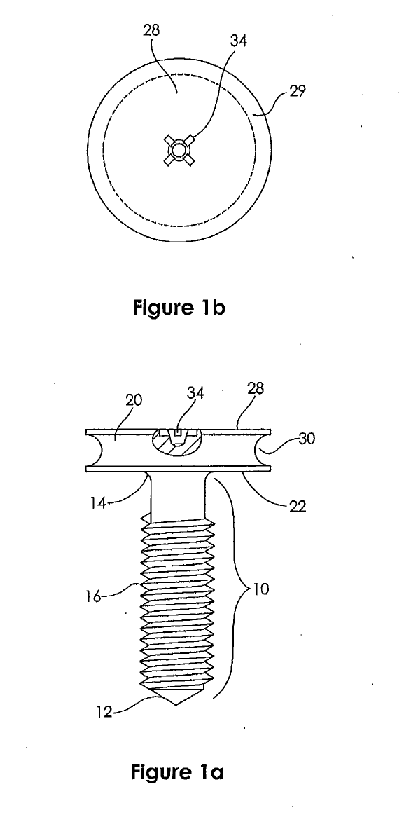

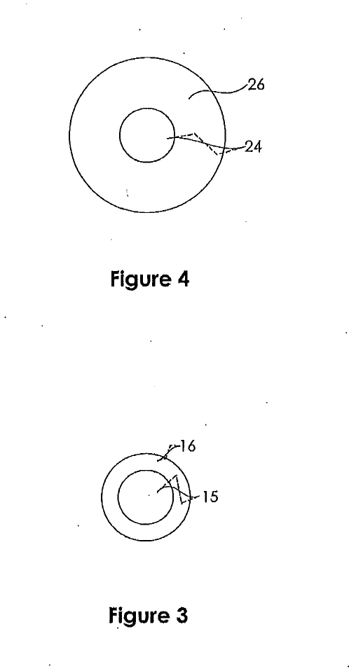

A first preferred embodiment of the invention comprises a shaft 10 comprising a pointed first end 12, and a second end 14 opposite the first end, as shown in FIG. 1a. The second end has a shaft cross sectional area 15 and helical male threads 16 mounted on the shaft, as shown in FIG. 3. The size and pitch of the helical threads will vary depending upon a number of factors, including the size of the shaft and the material that the shaft is intended to penetrate. Persons of ordinary skill in the fastening arts will be familiar with various thread designs for penetrating various materials, including wood, aluminum, and sheet metal. The threads may be either right handed or left handed, In one preferred embodiment, the helical threads extend at least 80% of the entire length of the shaft, as shown in FIGS. 1a and 6.

This first embodiment further comprises a disc member 20 comprising a first planar surface 22 defining a plane having a surface area that is at least four times the shaft cross sectional area and comprising an outer perimeter region 26 and a central region 24 attached to the second end of the shaft such that the shaft extends outward from the first planar surface at a substantially right angle to the plane defined by the first planar surface, as shown in FIGS. 1a and 4.

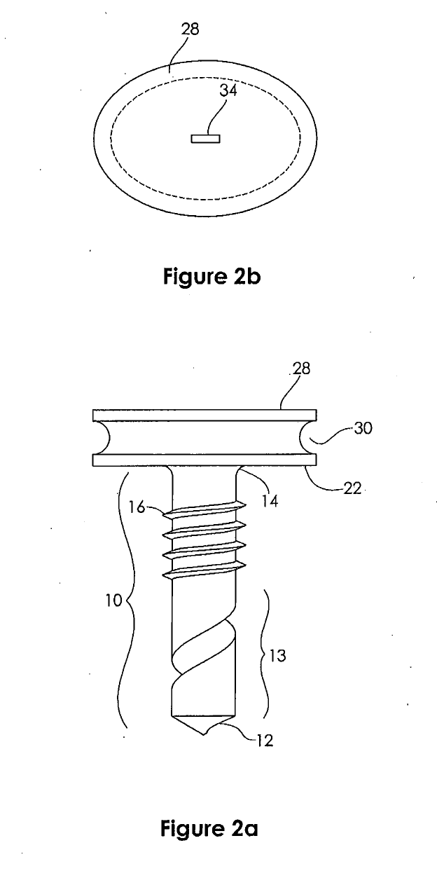

The disc member further comprises a second planar surface 28 opposite the first planar surface and comprising an outer perimeter region 29, as shown in FIG. 1b. In one preferred embodiment, the disc member is circular, as shown in FIG. 1b. In another preferred embodiment, the disc member is elliptical, as shown in FIG. 2b. In another preferred embodiment, the surface area of the first planar surface is at least sixteen times the shaft cross sectional area. In one preferred embodiment, the disc has a thickness of at least 0.125 inches, In another preferred embodiment, the shaft has a length of at least one inch and a diameter of at least 0.25 inches.

The disc member further comprises an arcuate channel 30 connecting the outer perimeter regions of the first and second planar surfaces, as shown in FIGS. 1a and 1b. In one preferred embodiment, the channel defines a circular perimeter. In another preferred embodiment, the channel defines an elliptical perimeter. In another preferred embodiment, the channel comprises a curved inner surface, as shown in FIGS. 1a and 1b. In a preferred embodiment, the arcuate channel has a radius of curvature of 0.0625 inches. In another preferred embodiment, the arcuate channel has a depth of 0.125 inches.

In another preferred embodiment, the second planar surface compromises a driver receptacle 34 at its center, as shown in FIGS. 1b and 2b. The driver receptacle can be sized and configured to receive a variety of different drivers, known to those of ordinary skill in the mechanical arts, including screwdriver tips and Allen wrenches. In one preferred embodiment, the driver receptacle is sized to receive a Phillips head bit, as shown in FIG. 1b. In another preferred embodiment, the driver receptacle is sized to receive an Allen wrench. In another preferred embodiment, the driver receptacle comprises a linear slot, as shown in FIG. 2b. When the driver is inserted in the driver receptacle, rotation of the driver will result in rotation of the wall hanging load bearing device. Where the helical male threads are right handed, clockwise rotation of the driver will cause the shaft to advance. Where the helical male threads are left handed, counterclockwise rotation of the driver will cause the shaft to advance.

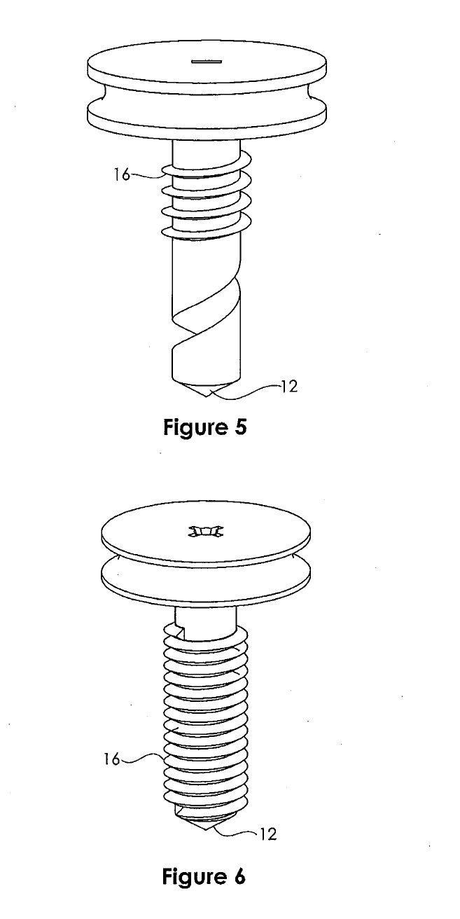

A second preferred embodiment of the invention is shown in FIGS. 2a and 5. A second preferred embodiment of the invention comprises a shaft 10 comprising a pointed first end 12, and a second end 14 opposite the first end, as shown in FIG. 2a. The second end has a shaft cross sectional area 15, as shown in FIG. 1 In this second embodiment, the shaft comprises a first region 13 comprising the pointed first end and a second region comprising male helical threads 16, as shown in FIG. 2a. The threads may be either right handed or left handed. In a preferred embodiment, the first region is a drill bit, as shown in FIG. 2a. In one preferred embodiment the length of the first region is at least three times the length of the second region. In another preferred embodiment, the helical threads extend at least 60% of the entire length of the shaft.

As shown in FIG. 2a, the second preferred embodiment comprises a disc member, comprising a first planar surface 22, a second planar surface 28, and an arcuate channel 30 as described above for the first preferred embodiment. A preferred embodiment of the disc member may be circular or elliptical.

In one preferred embodiment, the channel defines a circular perimeter. In another preferred embodiment, the channel defines an elliptical perimeter. In a preferred embodiment, the surface area of the first planar surface is at least sixteen times the shaft cross sectional area.

The foregoing disclosure and description of the inventions are illustrative and explanatory. Various changes in the size, shape, and materials, as well as in the details of the illustrative construction and/or an illustrative method may be made without departing from the spirit of the invention.

What is claimed is:

1. A wall hanging load bearing device, comprising:
a shaft comprising a pointed first end, and a second end opposite the first end, said second end having a shaft cross sectional area;
b. helical male threads mounted on the shaft;
c. a disc member comprising:
i. a first planar surface defining a plane having a surface area that is at least four times the shaft cross sectional area and comprising an outer perimeter region and a central region attached to the second end of the shaft such that the shaft extends outward from the first planar surface at a substantially right angle to the plane defined by the first planar surface;
ii. a second planar surface opposite the first planar surface and comprising an outer perimeter region; and
iii. an arcuate channel connecting the outer perimeter regions of the first and second planar surfaces.

2. The device of claim 1, wherein the disc member is circular.

3. The device of claim 1, wherein the disc member is elliptical.

4. The device of claim 1, wherein the channel defines a circular perimeter.

5. The device of claim 1, wherein the channel defines an elliptical perimeter.

6. The device of claim 1, wherein the channel comprises a curved inner surface.

7. The device of claim 1, wherein the helical threads extend at least 80% of the entire length of the shaft.

8. The device of claim 1, wherein the second planar surface comprises a driver receptacle at its center.

9. The device of claim 8, wherein the driver receptacle is sized to receive a Phillips head bit.

10. The device of claim 8, wherein the driver receptacle comprises a linear slot.

11. device of claim 1, wherein the shaft comprises a first region comprising the pointed first end and a second region comprising said helical threads.

12. The device of claim 11, wherein the first region is a drill bit.

13. The device of claim 1, wherein the surface area of the first planar surface is at least 16 times the shaft cross sectional area.

14. A wall hanging load bearing device, comprising:
a. a shaft comprising:
i. a first region comprising a pointed first end;
ii. a second region connected to the first region and comprising a second end opposite the first end said second end having a shaft cross sectional area; and
iii. helical male threads mounted on the shaft;
b. a disc member comprising:
i. a first planar surface defining a plane having a surface area that is at least four times the shaft cross sectional area and comprising an outer perimeter region and a central region attached to the second end of the shaft such that the shaft extends outward from the first planar surface at a substantially right angle to the plane defined by the first planar surface;
ii. a second planar surface opposite the first planar surface and comprising an outer perimeter region; and
iii. an arcuate channel connecting the outer perimeter regions of the first and second planar surfaces.

15. The device of claim 1, wherein the first region is a drill bit.

16. The device of claim 14, wherein the surface area of the first planar surface is at least 16 times the shaft cross sectional area.

17. device of claim 14, wherein the disc member is circular.

18. The device of claim 14, wherein the disc member is elliptical.

19. The device of claim 14, wherein the channel defines a circular perimeter.

20. The device of claim 14, wherein the channel defines an elliptical perimeter.
